(19) United States
(12) Patent Application Publication
(10) Pub. No.: US 2025/0326459 A1
(43) Pub. Date: Oct. 23, 2025

(54) TRICYCLE PROPELLED BY A STAIR CLIMBER MECHANISM

(71) Applicant: Cassandra Montag, Pittsville, WI (US)

(72) Inventor: Cassandra Montag, Pittsville, WI (US)

(21) Appl. No.: 18/639,652

(22) Filed: Apr. 18, 2024

(51) Int. Cl. B62M 1/28; B62K 5/02

(52) U.S. Cl. CPC B62M 1/28; B62K 5/02

(57) ABSTRACT

A tricycle propelled by the stair climber mechanism, including a main body, including a front bar assembly, a plurality of handle bars disposed at a top portion of the front bar assembly, a front wheel disposed at a bottom portion of the front bar assembly, and a rear bar assembly connected to the front bar assembly, a left rear wheel, a right rear wheel, a left pedal connected to a left front portion of the rear bar assembly, and a right pedal connected to a right front portion of the rear bar assembly, wherein the main body moves forward in response to the left pedal and the right pedal being pushed downward.

### BACKGROUND

### 1. Field

The present general inventive concept relates generally to a tricycle, and particularly, to a bicycle propelled by a stair climber mechanism.

### 2. Description of the Related Art

Conventional bicycles, tricycles, and scooters are often the most common and casual use of mobile transportation that also lends to a fitness routine.

These devices, however, do not offer a targeted workout for the gluteusmaximus.

Therefore, there is a need for mode of transportation that also dually functions as a workout for a user's gluteus maximus.

### SUMMARY

The present general inventive concept provides a tricycle propelled by a stair climber mechanism.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tricycle propelled by the stair climber mechanism, including a main body, including a front bar assembly, a plurality of handle bars disposed at a top portion of the front bar assembly, a front wheel disposed at a bottom portion of the front bar assembly, and a rear bar assembly connected to the front bar assembly, a left rear wheel connected to a left rear portion of the rear bar assembly, a right rear wheel connected to a right rear portion of the rear bar assembly, a left pedal connected to a left front portion of the rear bar assembly, and a right pedal connected to a right front portion of the rear bar assembly, wherein the main body moves forward in response to the left pedal and the right pedal being pushed downward.

The left pedal may automatically spring upward after the left pedal is pushed downward, and the right pedal may automatically spring upward after the right pedal is pushed downward.

A user may alternate stepping downward on the left pedal and then stepping downward on the right pedal to propel the tricycle propelled by the stair climber mechanism forward.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a rear top angled view of a tricycle propelled by a stair climber mechanism, according to an exemplary embodiment of the present general inventive concept; and

FIG. 2 illustrates a zoomed-in view of a stair climber assembly of the tricycle propelled by the stair climber mechanism of FIG. 1, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List Of Components

Bicycle Propelled by a Stair Climber Mechanism 100
Main Body 110
Front Bar Assembly 111
Upper Front Bar 111a
Lower Front Bar 111b
Front Bar Assembly to Rear Bar Assembly Connection Point 111c
Handle Bars 112
Rear Bar Assembly 113
Left Angled Bar 113a
Right Angled Bar 113b
Left Rear Wheel Attachment Bar 113c
Right Rear Wheel Attachment Bar 113d
Left Pedal Bar 113e
Right Pedal Bar 113f
Lateral Pedal Bar 113g
Guard Plate 114
Front Wheel 120
Left Rear Wheel 130
Left Rear Wheel Chain Connector 131
Right Rear Wheel 140
Left Pedal 150
Right Pedal 160
Stair Climber Assembly 170
Lateral Gear Bar 171
Chain Gear 172
Chain 173
Left Tension Band Gear 174
Left Tension Band 175
Right Tension Band Gear 176
Right Tension Band 177
Forward Propulsion Cylinder 178
Display Device 180
Basket 190

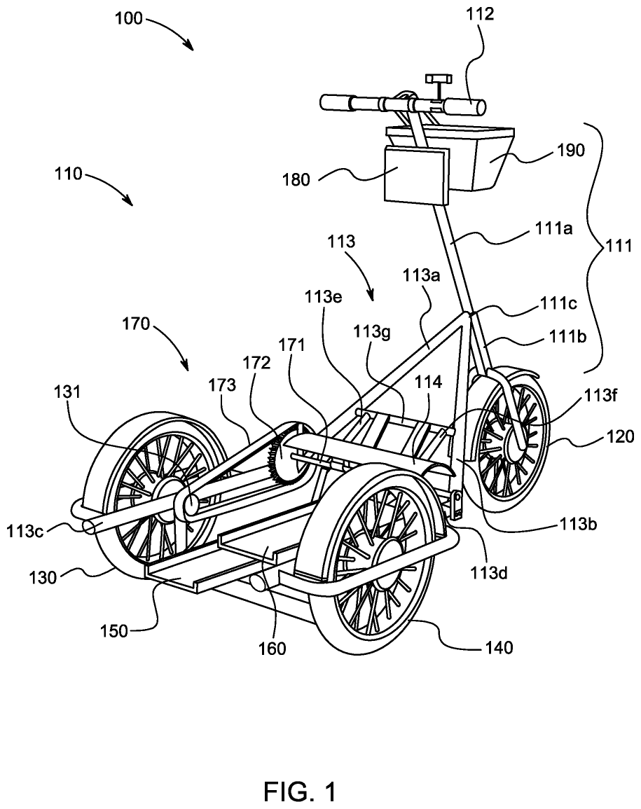

FIG. 1 illustrates a rear top angled view of a tricycle propelled by a stair climber mechanism 100, according to an exemplary embodiment of the present general inventive concept.

The tricycle propelled by the stair climber mechanism 100, and all components therein and/or connected thereto, may be constructed from at least one of metal, plastic, wood, silicone, cloth, circuitry, and rubber, etc., but is not limited thereto, and can be constructed from any material known to one of ordinary skill in the art.

Referring to FIG. 1, the tricycle propelled by the stair climber mechanism 100 may include a main body 110, a front wheel 120, a left rear wheel 130, a right rear wheel 140, a left pedal 150, a right pedal 160, a stair climber assembly 170, a display device 180, and a basket 190, but is not limited thereto.

The main body 110 may include a front bar assembly 111, a plurality of handle bars 112, a rear bar assembly 113, and a guard plate 114, but is not limited thereto.

The front bar assembly 111 may include an upper front bar 111a, a lower front bar 111b, and a front bar assembly to rear bar assembly connection point 111c, but is not limited thereto.

The upper front bar 111a may be connected to the plurality of handlebars 112 at an upper portion thereof. The upper front bar 111a may be connected to the lower front bar 111b at a bottom portion thereof.

The display device 180 and the basket 190 may be connected to a portion of the plurality of handlebars 112, but is not limited thereto. The display device 180n may be any type of display device that can display moving images and/or still images, and may be connected to a mobile device (not illustrated) via WIFI, BLUETOOTH, or any other type of wired or wireless connection.

The front bar assembly to rear bar assembly connection point 111c may be a point connecting the upper front bar 111a to the lower front bar 111b, and may also connect the front bar assembly 111 to the rear bar assembly 113.

The rear bar assembly 113 may include a left angled bar 113a, a right angled bar 113b, a left rear wheel attachment bar 113c, a right rear wheel attachment bar 113d, a left pedal bar 113e, a right pedal bar 113f, and a lateral pedal bar 113g, but is not limited thereto.

A top portion of the left angled bar 113a may be connected to a top portion of the right angled bar 113b at a point at and/or near the front bar assembly to rear bar assembly connection point 111c.

A bottom portion of the left angled bar 113a may be connected to a first end portion of the left rear wheel attachment bar 113c.

A second end portion of the left angled bar 113a may be connected to the left rear wheel 130.

A bottom portion of the right angled bar 113b may be connected to a first end portion of the right rear wheel attachment bar 113d.

A second end portion of the right angled bar 113b may be connected to the right rear wheel 140.

The lateral pedal bar 113g may connect the left angled bar 113a to the right angled bar 113b.

A first end of the left pedal bar 113e may be pivotably connected to the lateral pedal bar 113g, and a second end of the left pedal bar 113e may be connected to the left pedal 150.

A first end of the right pedal bar 113f may be pivotably connected to the lateral pedal bar 113g, and a second end of the right pedal bar 113f may be connected to the right pedal 160.

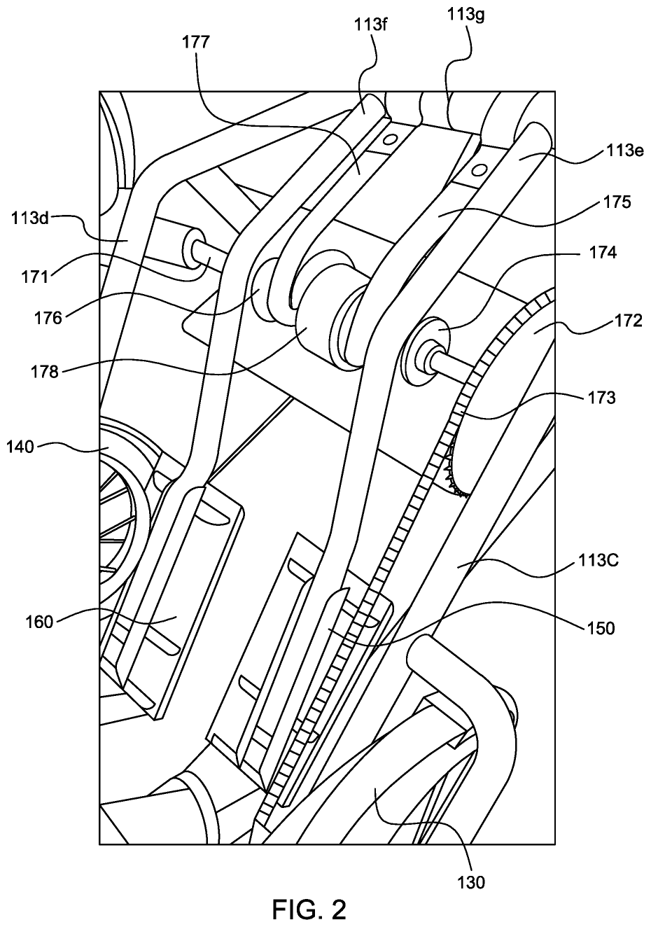

FIG. 2 illustrates a zoomed-in view of a stair climber assembly 170 of the tricycle propelled by the stair climber mechanism 100 of FIG. 1, according to an exemplary embodiment of the present general inventive concept.

Referring to FIGS. 1 and 2, the stair climber assembly 170 may include a lateral gear bar 171, a chain gear 172, a chain 173, a left tension band gear 174, a left tension band 175, a right tension band gear 176, a right tension band 177, and a forward propulsion cylinder 178, but is not limited thereto.

The lateral gear bar 171 may connect the left rear wheel attachment bar 113c to the right wheel attachment bar 113d, such that the lateral gear bar 171 is rotatable.

A left end of the lateral gear bar 171 may also be connected to the gear 172. The guard plate 114 may cover the lateral gear bar 171.

The chain 173 may wrap around the gear 172 at a first end, and may wrap around the left rear wheel chain connector 131 at a second end.

The left rear wheel chain connector 131 may connect the chain 173 to the left rear wheel 130, such that a rotation of the gear 172 causes the chain 173 to also rotate, thereby resulting in the left rear wheel 130 also rotating.

The a left tension band gear 174, the right tension band gear 176, and the forward propulsion cylinder 178 may be disposed on the lateral gear bar 171.

The left tension band 175 may have a first end disposed on the lateral pedal bar 113g and a second end disposed on the lateral gear bar 171.

The right tension band 177 may have a first end disposed on the lateral pedal bar 113g and a second end disposed on the lateral gear bar 171.

As such, when a user steps on the left pedal 150, the lateral gear bar 171 may pivot, thereby causing the left tension band gear 174 to also pivot, thereby causing tension to be exerted on the left tension band 175, thereby causing a rotational force to be transferred to the forward propulsion cylinder 178 as well as the gear 172, which causes the gear 172 to rotate. As the gear 172 rotates, the chain 173 moves in a circular direction about the gear 172 and the left rear wheel chain connector 131, thereby transferring rotational energy to the left wheel 130 to cause the left wheel 130 to rotate, thus causing the tricycle propelled by the stair climber mechanism 100 to moveforward.

Likewise, when the user steps on the right pedal 160, the lateral gear bar 171 may pivot, thereby causing the right tension band gear 176 to also pivot, thereby causing tension to be exerted on the right tension band 177, thereby causing a rotational force to be transferred to the forward propulsion cylinder 178 as well as the gear 172, which causes the gear 172 to rotate. As the gear 172 rotates, the chain 173 moves in a circular direction about the gear 172 and the left rear wheel chain connector 131, thereby transferring rotational energy to the left wheel 130 to cause the left wheel 130 to rotate, thus causing the tricycle propelled by the stair climber mechanism 100 to moveforward.

In other words, the stepping on the left pedal 150 and the right pedal 160 causes the left wheel 130 to rotate, and therefore, the stair climber assembly 170 controls the left wheel 130 to rotate.

Accordingly, instead of a user pedaling pedals in a circular motion, as is done when propelling a conventional bicycle or tricycle forward, the user can simply step up and down, similarly to a stair climber athletic workout machine, in order to propel the tricycle propelled by the stair climber mechanism 100 forward.

In other words, a conventional bicycle moves forward by having its pedals moving in a circular motion, while the tricycle propelled by the stair climber mechanism 100 moves forward by having the left pedal 150 and the right pedal 160 move vertically up and down, independently of each other.

Alternatively, a second gear and a second chain may be provided in a manner similar to the gear 172 and the chain 173, such that the right wheel 140 is controlled by the stair climber assembly 170 to rotate.

The present general inventive concept may include a tricycle propelled by the stair climber mechanism 100, including a main body 110, including a front bar assembly 111, a plurality of handle bars 112 disposed at a top portion of the front bar assembly 111, a front wheel 120 disposed at a bottom portion of the front bar assembly 111, and a rear bar assembly 113 connected to the front bar assembly 111, a left rear wheel 130 connected to a left rear portion of the rear bar assembly 113, a right rear wheel 140 connected to a right rear portion of the rear bar assembly 113, a left pedal 150 connected to a left front portion of the rear bar assembly 113, and a right pedal 160 connected to a right front portion of the rear bar assembly 113, wherein the main body moves forward in response to the left pedal 150 and the right pedal 160 being pushed downward.

The left pedal 150 may automatically spring upward after the left pedal 150 is pushed downward, and the right pedal 160 may automatically spring upward after the right pedal 160 is pushed downward.

A user may alternate stepping downward on the left pedal 150 and then stepping downward on the right pedal 160 to propel the tricycle propelled by the stair climber mechanism 100 forward.

A main purpose of the present general inventive concept is to provide users with a mobile stair climber device as an option for transport. Ingenious and practical, the present general inventive concept offers a modern and dynamic bike design that effectively targets and tones one's glutes during utilization. Expanding on the initial design of a tricycle, the present general inventive concept introduces a novel exercise machine that features a stable frame possessing three wheels for balance and control. The pedals' vertical motion mirrors stair-climbing, directly targeting the glute muscles as a person navigates the bike while exercising. The handlebar provides steady support, and any bicycle/tricycle braking system known to one of ordinary skill in the art may be attached to the handlebars and wheels to allow the bicycle to stop, thereby ensuring safety during mobile workout sessions. To further enhance functionality, the present general inventive concept may include a phone holder to keep individuals entertained, a basket for carrying belongings, and a step/distance counter to track progress. This innovative, top-quality product is engineered to target the glutes, and allows users to engage in a more comprehensive effective workout while riding around, for fun or for primary transport. As a result, the present general inventive concept may prove to be essential in the sport/fitness industry.

The present general inventive concept is the only product of its kind that merges the benefits of a stair climber with the convenience of casual mobility. This unprecedented product is uniquely designed with specialized up-and-down pedal motion that mirrors the stair-climbing movement, effectively sculpting the glutes and enhancing cardiovascular endurance. Moreover, the present general inventive concept is carefully crafted with durable, high-quality materials to ensure long-term stability and can easily become a go-to option for fitness focused individuals and/or tourists who prefer a casual way to explore a city or town while gaining the benefit of a workout.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tricycle propelled by the stair climber mechanism,
comprising: a main body, comprising:
a front bar assembly,
a plurality of handle bars disposed at a top portion of the front bar assembly,
a front wheel disposed at a bottom portion of the front bar assembly, and
a rear bar assembly connected to the front bar assembly;
a left rear wheel connected to a left rear portion of the rear bar assembly;
a right rear wheel connected to a right rear portion of the rear bar assembly;
a left pedal connected to a left front portion of the rear bar assembly; and
a right pedal connected to a right front portion of the rear bar assembly, wherein the main body moves forward in response to the left pedal and the right pedal being pushed downward.

2. The tricycle propelled by the stair climber mechanism of claim 1, wherein the left pedal automatically springs upward after the left pedal is pushed downward, and the right pedal automatically springs upward after the right pedal is pushed downward.

3. The tricycle propelled by the stair climber mechanism of claim 1, wherein a user alternates stepping downward on the left pedal and then stepping downward on the right pedal to propel the tricycle propelled by the stair climber mechanism forward.
